(19) United States
(12) Patent Application Publication
(10) Pub. No.: US 2020/0117625 A1
(43) Pub. Date: Apr. 16, 2020

(54) MANAGEMENT OF FAULT NOTIFICATIONS

(71) Applicant: Intel Corporation, Santa Clara, CA (US)

(72) Inventors: John J. BROWNE, Limerick (IE); Sunku RANGANATH, Beaverton, OR (US); Jabir KANHIRA KADAVATHU, Hillsboro, OR (US); Shobhi JAIN, Shannon (IE); Emma L. FOLEY, Killorglin (IE); Timothy VERRALL, Pleasant Hill, CA (US); John O'LOUGHLIN, Shannon (IE); Krzysztof KEPKA, Gdansk (PL)

(21) Appl. No.: 16/716,417

(22) Filed: Dec. 16, 2019

Related U.S. Application Data
(60) Provisional application No. 62/783,008, filed on Dec. 20, 2018.

(51) Int. Cl. G06F 13/24; G06F 13/12; G06F 13/42; G06F 13/16; G06F 11/10; G06F 11/07

(52) U.S. Cl. CPC G06F 13/24; G06F 13/128; G06F 13/4221; G06F 11/0757; G06F 11/1044; G06F 11/102; G06F 11/0793; G06F 13/1668

(57) ABSTRACT

Examples described herein relate to configuring an interrupt controller to gather zero or more interrupts of a first type and provide the zero or more interrupts of the first type to a first core after a threshold amount of time has elapsed. The interrupt controller is configured to transfer interrupts of a second type to a second core that executes at least one network protocol processing-related task. However, in some examples, the first core can perform any network protocol processing-related task. The first type of interrupts can be associated with faults that are correctable by an interrupt issuer or its delegate. The first core can be configured to perform a corrective action and acknowledge receipt of the group of interrupts or to merely acknowledge receipt of the group of interrupts but not perform a corrective action.

### RELATED APPLICATION

The present application claims the benefit of a priority date of U.S. provisional patent application Ser. No. 62/783,008, filed Dec. 20, 2018, the entire disclosure of which is incorporated herein by reference.

### BACKGROUND

In a computer system, an interrupt request (IRQ) is a hardware signal sent to a processor that halts a program and allows an interrupt handler to run. Hardware interrupts are used to handle events such as processing packets or data from a network interface, responding to inputs from peripheral interfaces (e.g., keyboard, mouse, or touch screen), and so forth. A hardware interrupt can be sent to the central processing unit (CPU) using a system bus. A software interrupt is a hardware instruction which causes an interrupt processing routine to be invoked. Interrupts can be masked so that particular interrupts are serviced (or not) according to the Interrupt Mask Register (IMR), which contains a single bit (allow or inhibit) for each cause of interrupt. Non-Maskable Interrupts (NMI) are high priority interrupts. A corresponding bit can be set to report which device is requesting an interrupt.

### BRIEF DESCRIPTION OF THE DRAWINGS

FIG. 1 depicts an example process whereby an interrupt can cause a processor to halt its operation to handle the interrupt.

FIG. 2 shows performance impact on a bare-metal Data Plane Development Kit (DPDK) L3 Forwarding performance application.

FIG. 3 indicates the performance drop in performance due to the injection of one corrected memory error per second.

FIG. 4 depicts an example system.

FIG. 5 depicts an example process.

FIG. 6 depicts an example environment.

FIG. 7 depicts a system.

FIG. 8 depicts an example environment.

FIG. 9 depicts a network interface that can use embodiments or be used by embodiments.

### DETAILED DESCRIPTION

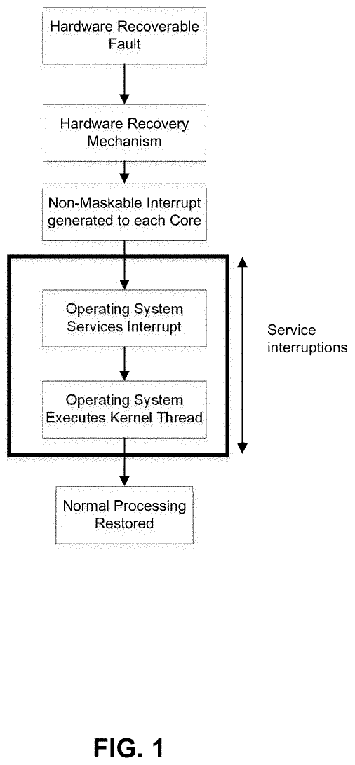

FIG. 1 depicts an example process whereby an interrupt can cause a processor to halt its operation to handle the interrupt. A machine check exception occurs when there is an error that hardware cannot correct. A machine check exceptions subsystem offers an Operating System (OS) an opportunity to take corrective action. However, a machine check exception will cause the central processing unit (CPU) to interrupt its currently executing program and call a special exception handler. These interrupts are non-maskable (NMI) and neither turning off the interrupt request (IRQ) balance or any of the OS enhancements like CPU isolation, and so forth prevent these interrupts from occurring on all the CPU cores. These interrupts cannot be intercepted, and cannot be masked, unlike other interrupts.

For example, when a memory fault is detected (e.g., a memory found a bit error and corrected the error), a processor or an interrupt controller generates an interrupt to be serviced by multiple cores. This causes interruptions to applications running across a system, even when a single core/resource is affected. If these faults occur on multiple resources or a fault occurs multiple times on a single resource, each interrupt has to be addressed across all cores. As a result, cores interrupt normal processing to handle this event (in software). Servicing the memory fault interrupts core operations such as packet processing and other activities of all cores that receive the interrupt. For example, cores dedicated to packet processing or cores dedicated to real-time scheduling stop their operations in order to execute a kernel thread to handle the interrupts. In a Network Function Virtualization (NFV) environment, this causes interruptions to all applications, even those that are not directly affected. This can contribute to unacceptable levels of service outage.

Stopping and resuming the operation of processing involves time-intensive acts of saving a state of a currently-executing process to a stack, reloading the state, and resuming operation of the process. Accordingly, interrupting a process delays its completion. For example, an OS stops its operations to handle interrupts.

Recurring errors can contribute significantly to performance degradation, even though the same corrective action may be able to address multiple faults. The handling of hardware recoverable faults also effects the determinism of the workload performance. If these interrupts occur on more than one resource, or frequently recur, this can lead to an inability for Communications Service Providers (CoSPs) to meet their strict service level agreements (SLAs) concerning workload performance and/or perform effective capacity planning as there can be an increase in performance uncertainty.

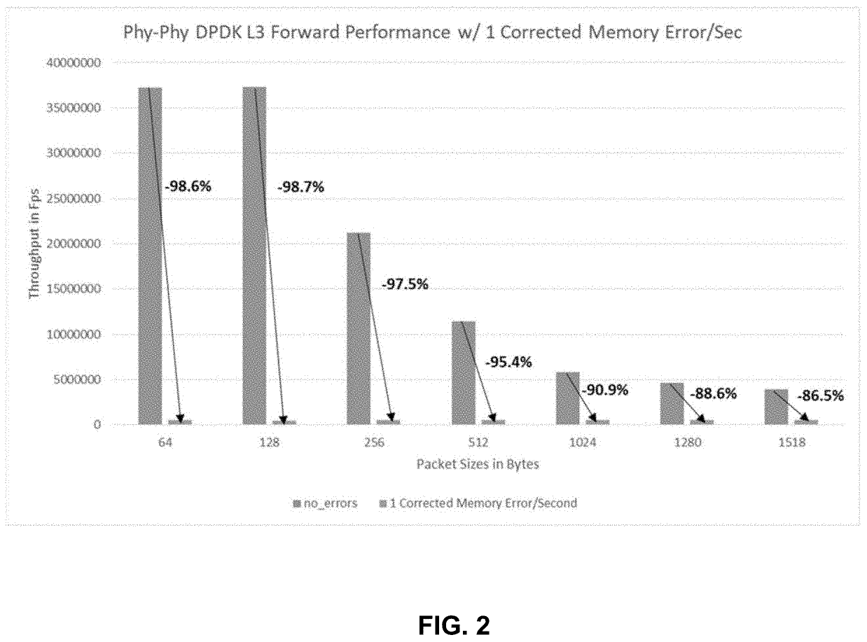

FIG. 2 shows performance impact on a bare-metal Data Plane Development Kit (DPDK) L3 Forwarding performance application where interrupts are generated by a memory device that detects a bit error with one (1) corrected memory error/second. As shown, there can be a very significant degradation in throughput in frames per second arising from delays invoked by servicing interrupts related to bit errors.

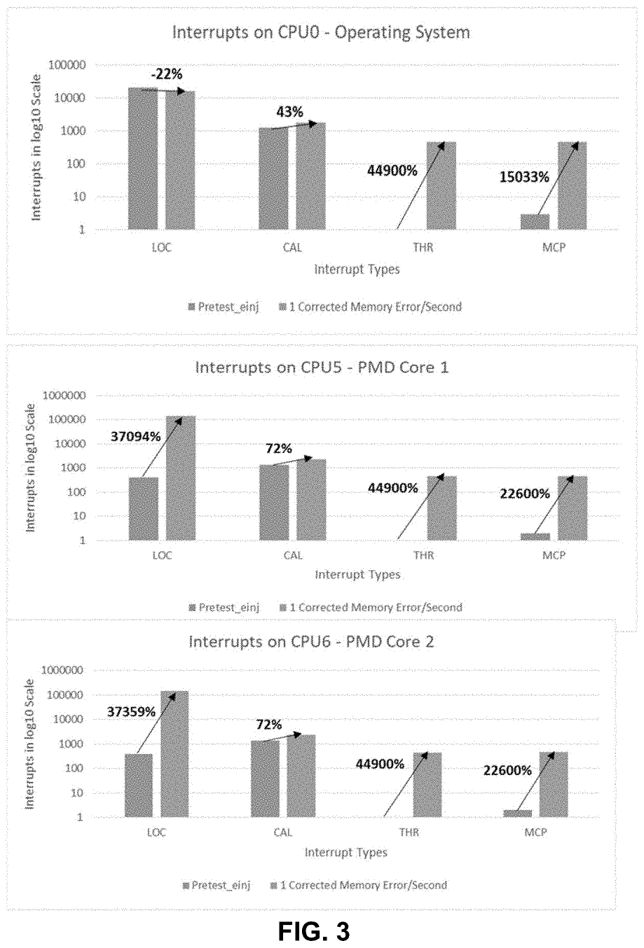

FIG. 3 indicates a performance drop in DPDK L3 Forwarding performance arising from a large increase in interrupts due to an injection of one corrected memory error per second with an EINJ tool set to a random memory address. An EINJ Test method to Cause RAS Faults can be as follows.

$ root@ah09-01-wp:~# cat einj
#!/bin/bash
cd /sys/kernel/debug/apei/einj/
echo 0x12345000 > param1 # Set memory address for injection
echo $((−1 << 12)) > param2 # Mask 0xfffffffffffff000 - anywhere in this page
echo 0x8 > error_type # Choose correctable memory error
echo 1 > error_inject # Inject now
$while true; do ./einj; sleep 1; done

In the example of FIG. 3, LOC refers to Local Timer Interrupts, CAL refers to Function Call Interrupts, THR refers to Threshold Interrupts, and MCP refers to Machine Check Polls Interrupts. As shown, interrupts related to 1 corrected memory error/second can lead to significant increases in number of interrupts.

Existing solutions to reduce interrupts provided to cores include interrupt masking, interrupt steering interrupt balancing, and CPU isolation. Interrupt masking allows execution of a device interrupt source or source group to be disabled (masked). Execution of a software interrupt (e.g., trap or exception or signal) can also be masked. Most standard interrupt sources are maskable.

Interrupt steering hardware feature configures the interrupt controller so that the decision to service an interrupt with a particular CPU is made at the hardware level, with no intervention from the kernel. This feature allows interrupts to be steered away from cores, to specific cores. Interrupt balancing (e.g., Linux irqbalance) provides an Irqbalance daemon that distributes hardware interrupts across CPUs in a multi-core system in order to increase performance. An example CPU isolation is the Linux CPU isolation feature (isolcpus) which allows cores to be isolated from other tasks in the system and isolates the cores from running any load, other than the load that is explicitly pinned to these cores.

However, existing solutions to reduce interrupt processing may not address the issue of excessive interrupts when interrupts are given special treatment and circumvent the existing solutions. For example, an interrupt may receive special treatment as being identified as non-maskable, non-steerable, ignore IRQ balance, or ignore isolation.

Various embodiments re-distribute and group interrupt events to reduce the impact of hardware recoverable interrupt events on critical workloads. Various embodiments limit a blast radius of faults to a selected one or more cores. Various embodiments can limit or restrict interrupt propagation. Interrupt steering can be used to move some interrupts away from cores designated as critical to cores designated as non-critical. Interrupt coalescing can be used to accumulate interrupts over a time period and trigger corrective behavior for a group of faults/interrupts one or more times per time period instead of triggering behavior for every individual fault. Interrupt steering and coalescing can be used independently or in combination. For example, interrupt steering directs interrupts to specific cores and can be used as a standalone approach or combined with coalescing. Interrupt coalescing can be used standalone to batch handling of any type of corrective actions together, after multiple faults occur, limiting the number of kernel thread activations to handle interrupts. For example, kernel thread activations can be used by any operating system including Linux®, Microsoft Windows®, Android®, iOS®, MacOS®, and so forth. Type and time threshold adjustment options can be used to fine tune the steering or coalescing options. Reference to interrupts herein can in addition, or alternatively, refer to QuickPath Interconnect (QPI) faults, peripheral component interconnect express (PCIe) faults, any notifications, and so forth.

When interrupt coalescing is used to aggregate errors, fewer corrective actions are invoked and the total time to resolve the errors can be reduced as well by batching the corrective actions. General service availability can be improved for certain selected cores because indication interrupt processing is steered, in some cases, to non-critical cores and multiple indications are combined into a single indication.

Various embodiments provide for reducing a range of uncertainty in estimating capacity and throughput of cores or other interruptible processors, potentially reducing cost as well as increasing performance. Various embodiments can address the problem of multiple hardware recoverable faults causing up to 98% packet drop interruption in software-defined networking (SDN) or NFV applications. The projected service available improvement is from approximately 10% service availability with the existing methods, to greater than 90% service availability with various embodiments under high fault conditions.

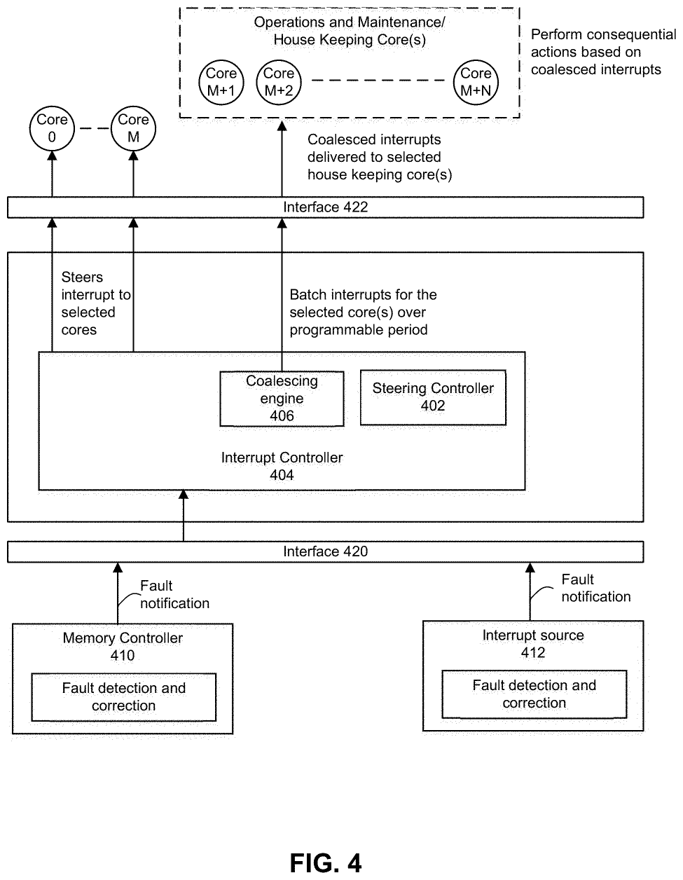

FIG. 4 depicts an example system. In this example, memory controller 410 and interrupt source 412 can issue interrupts as a result of errors or conditions detected. In this example, memory controller 410 for a memory or storage device (not depicted) performs a memory error detection and correction of 1 bit errors (e.g., using error correction coding (ECC)). Memory controller 410 can provide a fault notification to interrupt controller 404 that a 1 bit error memory fault was detected and corrected. Other hardware or software errors that are detected for example by interrupt source 412 and corrected and that generate interrupts can use embodiments described herein. In this example, memory controller 410 and interrupt source 412 can be locally or remotely connected to interrupt controller 404. For example, interface 420 can provide a connection between memory controller 410 and interrupt source 412 and interrupt controller 404 in accordance with one or more of: any bus standard or specification, any interconnect standard or specification, Ethernet, PCIe, Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, CCIX, 3GPP Long Term Evolution (LTE) (4G), 3GPP 5G, and variations thereof.

The system can include one or multiple cores 0 to M+N, where M and N are integers. Cores 0 to M+N can process interrupts received at least from interrupt controller 404. A core can be any or a combination of: a processor core, central processing unit (CPU), graphics processing unit (GPU), programmable logic device (PLD), field programmable gate array (FPGA), or application specific integrated circuit (ASIC). Cores can access a cache or memory (not depicted) to execute instructions or access or store data or content.

A driver or operating system executed by a core can configure steering controller 402 to select core(s) to which interrupt controller 404 is to deliver interrupts. In some examples, steering controller 404 can be integrated into interrupt controller 402 or can be implemented as separate hardware and/or core-executed software. Interrupt controller 404 can be implemented as separate hardware and/or core-executed software. For example, steering controller 404 can be configured to identify faults to be steered away from certain cores that execute time sensitive processes such as packet processing such as network protocol processing, real-time scheduling (e.g., packet egress or transmit scheduling), or service chaining tasks. Non-limiting examples of time sensitive processes are described later. However, in some examples, steering controller 404 can coalesce and steer faults to any core that executes time sensitive processes such as network protocol processing, real-time scheduling (e.g., packet egress or transmit scheduling), or service chaining tasks. In addition, or alternatively, steering controller 404 can be configured to cause coalescing engine 406 to group or coalesce certain faults or interrupts and provide the grouped faults or interrupts to a particular core or cores at or after certain time intervals. For example, non-maskable recoverable fault interrupts can be grouped or coalesced where non-maskable recoverable fault interrupts are recoverable or fixable errors but are indicated to an operating system. Interrupts of a particular type that are received over a time interval can be batched and sent or made available to selected core(s) at or after the time interval expires. Note that interrupts that are coalesced can be provided to a strict subset of cores (at least one but not all of the cores of a group). The coalesced interrupts can be provided to a first strict subset of cores and interrupts of a different type can be provided, without coalescing, to the same or different strict subset of cores.

Interrupt controller (or manager) 404 can use coalescing engine 406 to batch zero or more interrupts for delivery to selected core(s) over a programmable time period. Interrupt controller (or manager) 404 can be implemented as part of an operating system or any software, a configurable hardware device, or a fixed function hardware device. Coalescing engine 406 can be hardware and/or core-executed software such as a kernel driver. Coalescing engine 406 can perform a steering routine whereby in response to receipt of a particular fault notification (e.g., NMI), coalescing engine 406 coalesces or groups interrupts of a particular type. Coalescing engine 406 can send coalesced interrupt(s) (if any) to selected core(s) at time intervals. For example, selected cores M+1 to M+N can be considered housekeeping core(s) that do not execute time sensitive processes.

For example, time sensitive processes can include processes (e.g., processor-executable code segments) such as one or more of: DPDK-related tasks, 3GPP 5G, NFV, SDN (e.g., OpenFlow protocol from Open Networking Foundation), virtualized network function (VNF), cloud radio access network (CRAN or C-RAN), virtualized radio access network (VRAN) (e.g., for 5G virtual base stations), Evolved Packet Core (EPC), broadband remote access server (BRAS), or Broadband Network Gateway (BNG) workloads, service function chained operations, egress scheduling operations, or other packet processing related operations.

Some example implementations of NFV are described in European Telecommunications Standards Institute (ETSI) specifications or Open Source NFV Management and Orchestration (MANO) from ETSI's Open Source Mano (OSM) group. VNF can include a service chain or sequence of virtualized tasks executed on generic configurable hardware such as firewalls, domain name system (DNS), caching or network address translation (NAT) and can run as virtual machines (VMs) or in virtual execution environments. VNFs can be linked together as a service chain. In some examples, EPC is a 3GPP-specified core architectures at least for Long Term Evolution (LTE) access.

A virtualized execution environment can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux and Windows Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. The isolated nature of containers provides several benefits. First, the software in a container will run the same in different environments. For example, a container that includes PHP and MySQL can run identically on both a Linux computer and a Windows machine. Second, containers provide added security since the software will not affect the host operating system. While an installed application may alter system settings and modify resources, such as the Windows registry, a container can only modify settings within the container.

A RAN can provide access and coordinate management of base stations across sites. An example of a CRAN is provided by the China Mobile Research Institute. A CRAN can provide cloud computing-based architecture for radio access networks of 2G, 3G, 4G, 5G, and future wireless communication standards.

For example, one type of fault that could be configured to be grouped and released at time intervals to selected cores is a single bit error in memory that was detected and corrected and identified by memory controller 410. Another type of fault that could be configured to be grouped and released at time intervals to selected cores is a correctable data retrieval error corrected by an issuer of the interrupt (or a delegate device or processor-executed software) using error correction coding (ECC) or XOR data reconstruction. Another type of fault that could be configured to be grouped and released at time intervals to selected cores is a PCIe error or a QPI fault. Any type of interrupt can be configured to be grouped and released at time intervals. For example, Appendix A includes a list of potential faults that can be grouped and released at time intervals. Non-maskable recoverable fault interrupts are programmable and can change.

Steering controller 402 can configure coalescing engine 406 to coalesce interrupts of a particular type and release the group to a particular core or cores at time intervals. For example, a first type can be corrected 1 bit memory read errors and can be coalesced and sent as a group to a core M+1. A second type can be PCIe errors and can be and can be coalesced and sent as a group to a core M+2. Coalescing engine 406 can prioritize transfer of interrupts over other types of interrupts to core(s) based on a configuration. For example, the first type of faults can be prioritized to be transferred to any core over the second type.

For example, load balancing can be applied to steer interrupts of a certain type to one or more particular cores. For example, a fault type 0 can be steered to core M+1, fault type 1 steered to core M+2 and so forth. In an event that a number of faults received over a period of time exceeds a threshold, additional cores can be added to handle interrupts of a particular type. Conversely, if a total number of faults of different types are less than a second threshold, a core can be allocated to handle multiple types of faults. The cores across which load balancing is applied can perform time-sensitive operations or non-time-sensitive operations.

A format of a group of coalesced interrupts can identify a particular type of a fault (designated by a code) and number of faults of a particular type over a time interval. For example, coalescing engine 406 can generate a message that generates a sequence of a fault source code 0 a number of faults associated with fault source code 0, fault source code 1, number of faults associated with fault source code 1, and so forth. An example format shown below can be used for fault source codes and number of faults. A total number of faults over a time interval can be reported.

| Fault source code | Number of faults |
|---|---|
| 0 (corrected 1 bit errors) | 45 |
| 1 (ECC corrected errors) | 15 |
| 2 (PCIe errors) | 4 |

Interrupt controller 404 can interact with cores 0 to M+N using an interface 422. Note that any of cores 0 to M+N can be locally or remote connected to interrupt controller 404. Interface 422 can provide communications in compliance with any format described herein at least with respect to interface 420.

Any of cores M+1 to M+N can perform consequential actions based on coalesced interrupts such as notifying management system (e.g., baseboard management controller (BMC), Intelligent Platform Management Interface (IPMI), or device or software that performs any of those functions) or perform a corrective action to address the fault generated by the interrupt (e.g., warning or corrective actions). For example, receipt of an interrupt is counted by a hardware and/or software block (e.g., interrupt handler of an OS) and acknowledged by an interrupt handler of an OS. An acknowledgement can be provided to indicate receipt of a fault notice even if corrected by another device or software.

In some examples, any of cores M+1 to M+N can acknowledge receipt of faults only and kernel default behavior disabled so that corrective actions are not taken but the receipt of the NMIs or interrupts is acknowledged. In some examples, a single acknowledgement message is provided for a group of multiple faults of the same type. When multiple events occur within a programmable coalescing time span T, kernel system behavior (e.g., acknowledgement) is triggered only for the last occurrence of a fault type.

By contrast, cores 0 to M can poll fault flags provided by interrupt controller 404 to see if interrupts are present. Some examples of errors that transferred by interrupt controller 404 to a core 0 to M include uncorrectable errors such as operating system freezes or crashes. In some examples, cores 0 to M can execute time sensitive tasks. Although any of cores 0 to M+N can execute time or non-time sensitive tasks.

Various embodiments can be implemented by any device or software used by a cloud service provider, any device or software within a public cloud, any device or software within a hybrid cloud, remote access service (RAS) monitor, a baseboard management controller (BMC) that monitors the physical state of a computer, network server or other hardware device using sensors and communicating with the system administrator, firmware, Basic Input/Output System (BIOS), or Unified Extensible Firmware Interface (UEFI) extensions for RAS.

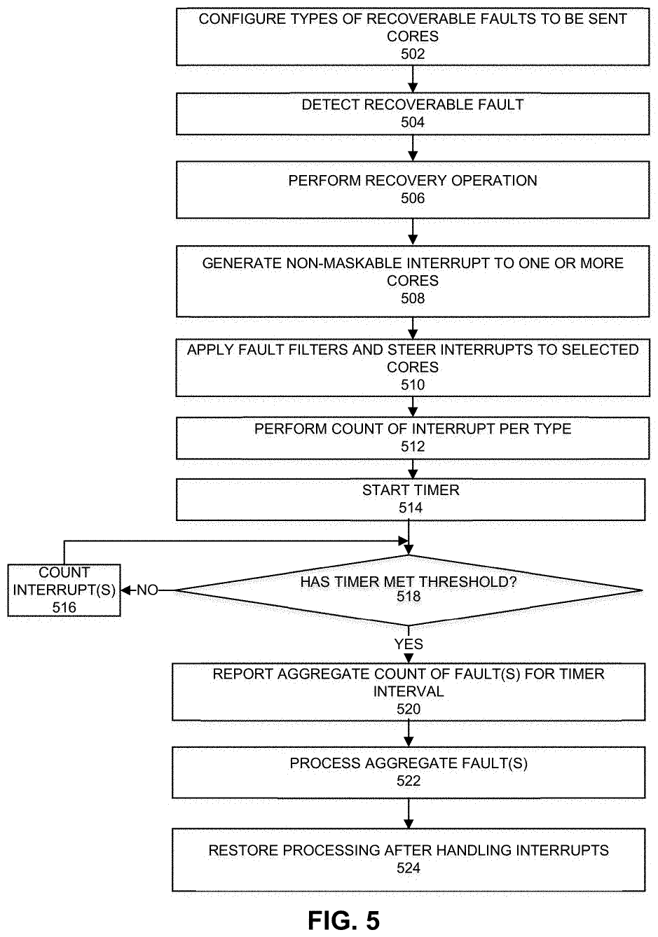

FIG. 5 depicts an example process. The process can be performed by an interrupt source, interrupt controller, a core, and/or steering controller to selectively coalesce certain types of interrupts to certain cores. Note that some types of interrupts are not coalesced and are transferred to select cores based on available detection and transfer technologies. At 502, types of recoverable faults to be sent to cores are configured. For example, recoverable faults can refer to types of interrupts that will not trigger an OS executed by a core to invoke its interrupt handler. Examples of a particular type of fault or interrupt is provided in Appendix A. Configuring a set of recoverable faults to be delivered to cores can prevent critical cores being overloaded with multiple fault types.

At 504, a recoverable fault is detected. A recoverable fault can include detection of a fault or interrupt that is hardware or software recoverable or correctable. For example, a recoverable fault can be a single or multiple bit error detection and correction can use error correction coding (ECC) or XOR recovery operations. At 506, a recovery operation can be performed by a device or software to attempt to address the recoverable fault. For example, a recovery operation can include use of error correction coding (ECC) or XOR recovery operations. Other examples include corrected PCIe faults or QPI faults. At 508, a Non-Maskable Interrupt (NMI) is generated to one or more cores. For example, a recoverable fault that is also subject to a recovery operation can also trigger generation of a Non-Maskable Interrupt (NMI) to one or more cores.

At 510, fault filters can be applied to steer interrupts to selected cores. For example, interrupts can be steered or filtered so that interrupts are sent to cores which have not been “opted out” of receiving notifications of recoverable errors via interrupts. Cores that are configured to not receive notifications of recoverable errors via interrupts can run time-sensitive packet processing tasks, scheduling, or service chained tasks. For example, load balancing can be applied to steer interrupts of a certain type to one or more particular cores so that any core is not disproportionately managing interrupts of a particular type or a particular number of interrupts.

At 512, a count of interrupt per type commences. At 514, a timer is started. In some examples, a countdown to zero can commence. At 516, fault interrupts are counted until the timer meets a threshold value (e.g., reaches zero or hits a prescribed upper value). At 518, a determination is made if a timer has met a threshold. If the timer has met a threshold, the process continues to 520. If the timer has not met a threshold, 516 is performed. At 520, an aggregate count of faults of a particular type can be reported to one or more cores. Faults can be reported individually or collectively. For example, faults can be counted and reported as a number of faults or interrupts of a particular type to a core that has been configured to receive coalesced fault(s). In addition or alternatively, a total number of faults regardless of type can be reported to a core that has been configured to receive coalesced fault(s).

In some examples, interrupts can be coalesced based on priority with an associated threshold. For example, priority level (n) interrupts can be coalesced over time period T and delivered/steered to a specific core. The controller can be programmed with coalescing rules and steering rules (e.g., by a driver or operating system) with the higher priority coalesced notifications delivered before lower priority coalesced notifications to selected core(s). For example, an interrupt type A can be memory error that is detected and corrected with priority level 2 and timer duration of N. An interrupt type B can be a non-recoverable core error with priority level 1 and timer duration of N. If both errors occur together and the timer N expires at or within an offset from each other, interrupts of type B are delivered first to a selected core and, next, interrupts of type A are delivered to the second core. In some examples, interrupts of type B are delivered before interrupts of type A whether interrupts of type A and B are to be delivered to the same core or any different cores.

At 522, faults are processed by one or more cores. For example, an operating system kernel thread executed by a core can process reported aggregate fault(s). The core can process multiple faults as a group so that an interrupt handler and corrective OS actions are only carried out one time per fault type to reduce service interruptions. A core can notify management system (e.g., baseboard management controller (BMC), Intelligent Platform Management Interface (IPMI), or device or software that performs any of those functions) or perform a corrective action to address the fault generated by the interrupt (e.g., warning or corrective actions).

At 524, the core can resume processing that took place prior to receiving a group of fault(s). For example, if a core saved process state to a stack, the core can copy the state and resume operation of the process.

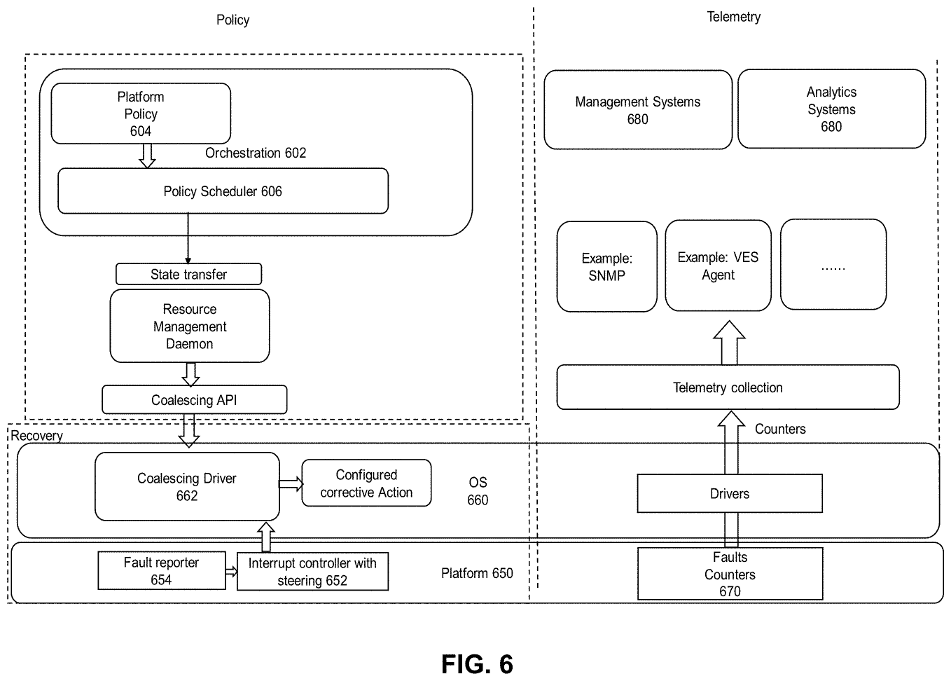

FIG. 6 depicts an example environment. Orchestrator 602 can run on hypervisor, network management system, SDN controller (e.g., vSphere). For example, orchestrator 602 can be implemented as an NFV MANO from ETSI's OSM group used in conjunction with policy scheduler 606 to configure coalescing of interrupt types and cores that are to receive coalesced interrupts or interrupts without coalescing. Platform policy 604 can configure policy scheduler 606. An example platform policy 604 is shown below.

| Recoverable RAS | | |
|---|---|---|
| Fault Policy | Example Usage | Technology |
| Default Linux | Used for non-critical | Applications are |
| behavior | services and applications. | interrupted as normal |
| | | using standard Linux |
| | | fault behavior. |
| Resilient | Used for NFV Packet | Uses coalescing to |
| Behavior | Processing Applications | minimize impact. |
| | such as EPC. | |
| | Platform is to deliver | |
| | optimal service (resiliency) | |
| | in the event of platform | |
| | recoverable errors related | |
| | to memory, storage, CPU, | |
| | PCI, PCIe. Apply coalescing | |
| | of interrupts related to | |
| | recoverable errors. | |
| Real-time | Used for timing accurate | Recoverable Faults are |
| behavior | or correct applications such | counted. |
| | as VRAN, CRAN, base | Linux OS corrective |
| | station Radio Network | actions are steered |
| | Controller (RNC). | away from the real- |
| | Reduces impact on timing | time cores to |
| | accurate cores (e.g., real- | housekeeping cores. |
| | time cores) from interrupts. | Uses steering to |
| | | isolate cores from |
| | | faults and coalescing |
| | | on packet processing |
| | | cores. |

Alternative policies include
(1) Faults can have individual coalescing periods for each type of fault
(2) Faults can be acknowledged only and the Linux (or other OS) kernel default behavior disabled so that corrective actions are not taken but the receipt of the NMIs or interrupts is acknowledged. Could be used for real-time services such as CRAN or VRAN.

Scheduler 606 can provide one or more policies for platform 650 and its OS 660 executed by one or more cores (not shown) to apply. In some examples, a REST API can be used to communicate policy 604 to a management entity (daemon) (e.g., running on a CPU of platform 650) and to driver 662 via a coalescing application program interface (API). For example, policy 604 can configure coalescing driver 662 to selectively coalesce certain types of interrupts over a period of time and indicate which core(s) to provide the interrupts to. In addition, policies 604 set what corrective actions a kernel is to take, if any, in response to receipt of one or more interrupts.

Platform interrupt controller 652 can be programmed with steering (e.g., which type of interrupts go to specific core(s)) and a coalescing (grouping) policy for which interrupt types to report as a group to driver 662 after receiving zero or more over a policy prescribed period of time.

Fault reporter 654 can indicate interrupts and reasons for interrupts (e.g., bit error, PCIe errors, and so forth) to interrupt controller 652. Fault reporter 654 can use fault counters 670 to indicate to a remote device interrupt types and numbers of interrupts for telemetry collection (e.g., using open source project Collectd). By use of telemetry collection, changes to configuration of a policy can be determined based on performance information of the system that uses the policy. For example, if a performance drop (e.g., packet processing latency increases) is detected for one or more cores, the policy can be adjusted to increase interrupt coalescing (time period) window. Simple Network Management Protocol (SNMP) (e.g., Internet Architecture Board (IAB) in RFC 1157) can be for receiving and providing information such as telemetry information. VES Agent of Open Platform for NFV (OPNFV) can be used to collect analytics and performance information of platform 650. Management and analytics systems 680 can determine a type of interrupt that is to be coalesced, a core to receive coalesced interrupts, and/or a time window to gather interrupts are all programmable. Accordingly, coalesced interrupt types, time window, and cores that process interrupts can be adjusted based on analytics.

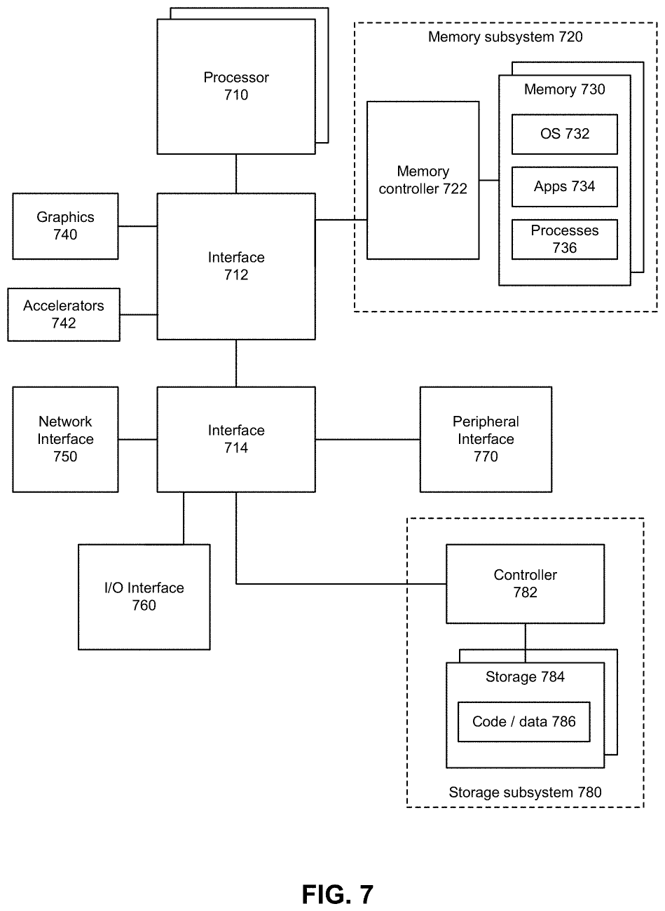

FIG. 7 depicts a system. The system can use embodiments described herein to control and manage when specific types of interrupts are provided to cores or processors. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs).

Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. Various embodiments can be used in connection with network interface 750, processor 710, and memory subsystem 720.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (i.e., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (i.e., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version 3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet or part of the Internet, or public cloud, or private cloud, or hybrid cloud. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board.

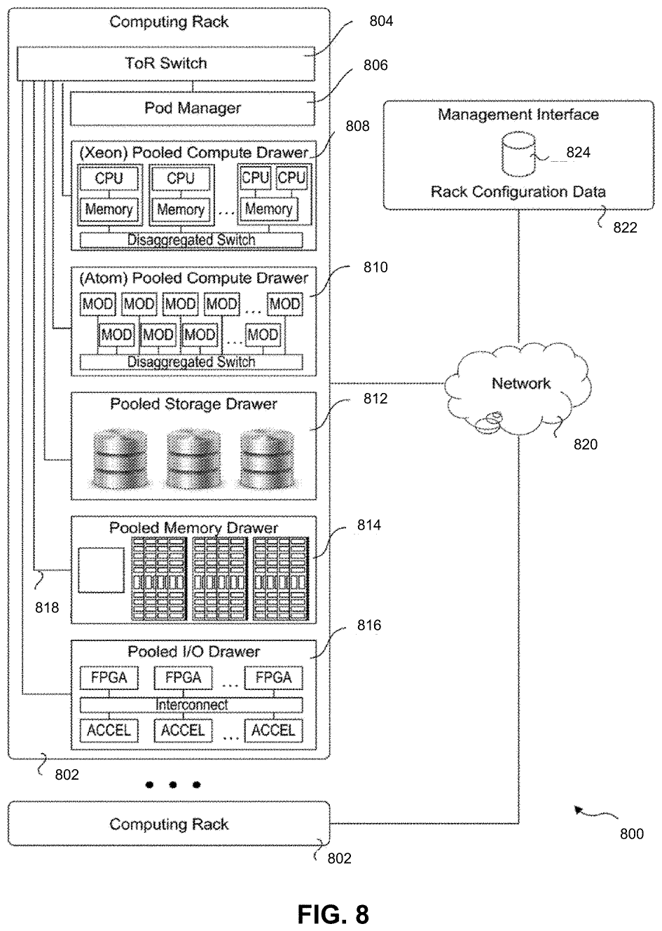

FIG. 8 depicts an environment 800 includes multiple computing racks 802, each including a Top of Rack (ToR) switch 804, a pod manager 806, and a plurality of pooled system drawers. Various embodiments can be used in a switch. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 808, and Intel® ATOM™ pooled compute drawer 810, a pooled storage drawer 812, a pooled memory drawer 814, and a pooled I/O drawer 816. Each of the pooled system drawers is connected to ToR switch 804 via a high-speed link 818, such as a 40 Gigabit/second (Gb/s) or 100 Gb/s Ethernet link or a 100+Gb/s Silicon Photonics (SiPh) optical link. In one embodiment high-speed link 818 comprises an 800 Gb/s SiPh optical link.

Multiple of the computing racks 802 may be interconnected via their ToR switches 804 (e.g., to a pod-level switch or data center switch), as illustrated by connections to a network 820. In some embodiments, groups of computing racks 802 are managed as separate pods via pod manager(s) 806. In one embodiment, a single pod manager is used to manage all of the racks in the pod. Alternatively, distributed pod managers may be used for pod management operations.

Environment 800 further includes a management interface 822 that is used to manage various aspects of the environment. This includes managing rack configuration, with corresponding parameters stored as rack configuration data 824.

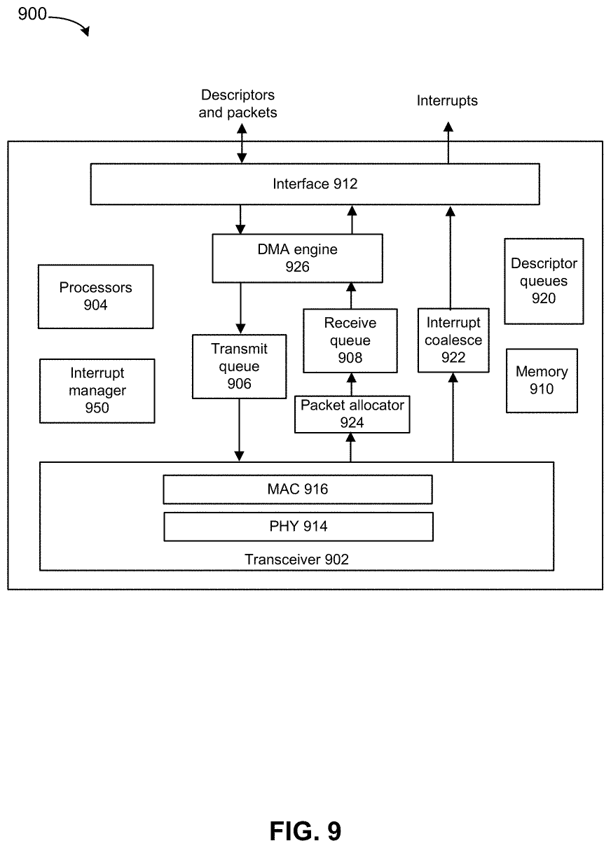

FIG. 9 depicts a network interface that can use embodiments or be used by embodiments. Various processors of network interface 900 can use techniques described herein to manage when interrupts are provided to a specific processors and what processors receive specific types of interrupts. Network interface 900 can include transceiver 902, processors 904, transmit queue 906, receive queue 908, memory 910, and bus interface 912, and DMA engine 926. Transceiver 902 can be capable of receiving and transmitting packets in conformance with the applicable protocols such as Ethernet as described in IEEE 802.3, although other protocols may be used. Transceiver 902 can receive and transmit packets from and to a network via a network medium (not depicted). Transceiver 902 can include physical layer (PHY) circuitry 914 and media access control (MAC) circuitry 916. PHY circuitry 914 can include encoding and decoding circuitry (not shown) to encode and decode data packets according to applicable physical layer specifications or standards. MAC circuitry 916 can be configured to assemble data to be transmitted into packets, that include destination and source addresses along with network control information and error detection hash values. MAC circuitry 916 can be configured to process MAC headers of received packets by verifying data integrity, removing preambles and padding, and providing packet content for processing by higher layers.

Processors 904 can be any a combination of a: processor, core, graphics processing unit (GPU), field programmable gate array (FPGA), application specific integrated circuit (ASIC), or other programmable hardware device that allow programming of network interface 900. For example, processors 904 can provide for allocation or deallocation of intermediate queues. For example, a “smart network interface” can provide packet processing capabilities in the network interface using processors 904.

Packet allocator 924 can provide distribution of received packets for processing by multiple CPUs or cores using timeslot allocation described herein or RSS. When packet allocator 924 uses RSS, packet allocator 924 can calculate a hash or make another determination based on contents of a received packet to determine which CPU or core is to process a packet.

Interrupt coalesce 922 can perform interrupt moderation whereby network interface interrupt coalesce 922 waits for multiple packets to arrive, or for a time-out to expire, before generating an interrupt to host system to process received packet(s). Receive Segment Coalescing (RSC) can be performed by network interface 900 whereby portions of incoming packets are combined into segments of a packet. Network interface 900 provides this coalesced packet to an application.

Direct memory access (DMA) engine 926 can copy a packet header, packet payload, and/or descriptor directly from host memory to the network interface or vice versa, instead of copying the packet to an intermediate buffer at the host and then using another copy operation from the intermediate buffer to the destination buffer.

Memory 910 can be any type of volatile or non-volatile memory device and can store any queue or instructions used to program network interface 900. Transmit queue 906 can include data or references to data for transmission by network interface. Receive queue 908 can include data or references to data that was received by network interface from a network. Descriptor queues 920 can include descriptors that reference data or packets in transmit queue 906 or receive queue 908. Bus interface 912 can provide an interface with host device (not depicted). For example, bus interface 912 can be compatible with peripheral connect Peripheral Component Interconnect (PCI), PCI Express, PCI-x, Serial ATA (SATA), and/or Universal Serial Bus (USB) compatible interface (although other interconnection standards may be used).

Interrupt manager 950 can selectively coalesce certain types of interrupts over a period of time and be configured to provide the interrupts to certain core(s).

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, scripted language, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes an apparatus that includes at least two cores and an interrupt manager coupled to the at least two cores, the interrupt manager to identify a type of interrupt related to errors to release to a selected strict subset of the at least two cores.

Example 2 includes any example, wherein the type of interrupt comprises a hardware or software correctable error.

Example 3 includes any example, wherein the type of interrupt includes a bit error corrected using error correction coding (ECC).

Example 4 includes any example, wherein the type of interrupt comprises one or more of: a PCIe error or a one-bit read error.

Example 5 includes any example, wherein the interrupt manager is to gather the type of interrupt during a time span release and release the gathered zero or more interrupts to the selected strict subset of the at least two cores based on completion of the time span.

Example 6 includes any example, wherein the selected strict subset of the at least two cores is to access interrupts of the type of interrupt and cause performance of a corrective action for the gathered zero or more interrupts.

Example 7 includes any example, wherein the selected strict subset of the at least two cores is to access interrupts of the type of interrupt and provide an acknowledgement of receipt of the interrupts but not perform a corrective action for the gathered zero or more interrupts.

Example 8 includes any example, and including a memory controller to issue an interrupt to the interrupt manager.

Example 9 includes any example, and including one or more of: a base station, macro base station, pico station, or nano station.

Example 10 includes any example, wherein the interrupt manager is to transfer to one or more cores interrupts that are associated with faults that are not correctable by an interrupt issuer or its delegate.

Example 11 includes any example, wherein the interrupt manager is to provide an interrupt without coalescing to a second core, the second core to perform a network protocol processing task related to one or more of: Data Plane Development Kit (DPDK) applications, 3GPP 5G protocol processing, Network Function Virtualization (NFV) operation, software-defined networking (SDN), virtualized network function (VNF), cloud radio access network (CRAN or C-RAN), virtualized radio access network (VRAN), Evolved Packet Core (EPC), broadband remote access server (BRAS), or Broadband Network Gateway (BNG) workloads.

Example 12 includes a method that includes: receiving an interrupt and determining whether to transfer the interrupt to a processor or to steer the interrupt to a second processor, wherein the processor is to perform network protocol processing, real-time scheduling, or service chaining operations.

Example 13 includes any example, and includes: determining to transfer the interrupt to the processor based on the interrupt referring to an error that is not correctable by an issuer of the interrupt or its delegate.

Example 14 includes any example, and includes: gathering a type of interrupt during a time span; providing zero or more interrupts of the type of interrupt to a third processor based on a timer expiring.

Example 15 includes any example, wherein the type of interrupt comprises a type of interrupt related to an error that is correctable by an issuer of the interrupt or its delegate.

Example 16 includes any example, wherein the type of interrupt comprises a single or multiple bit error that is correctable by an issuer of the interrupt or its delegate.

Example 17 includes any example, and includes: the third processor performing one or more of: a corrective action related to the interrupt or providing an acknowledgement of receipt of the interrupt.

Example 18 includes any example, wherein the network protocol processing comprise operations related to one or more of: Data Plane Development Kit (DPDK) applications, 3GPP 5G protocol processing, Network Function Virtualization (NFV) operation, software-defined networking (SDN), virtualized network function (VNF), cloud radio access network (CRAN or C-RAN), virtualized radio access network (VRAN), Evolved Packet Core (EPC), broadband remote access server (BRAS), or Broadband Network Gateway (BNG) workloads.

Example 19 includes a computer-readable medium, comprising instructions stored thereon, that if executed cause at least one processor to: configure interrupt management features to transfer interrupts of a first type to a first core and configure interrupt management features to transfer interrupts of a second type to a second core, wherein the second core is to execute any packet processing-related task.

Example 20 includes any example, wherein the first type comprises a hardware or software correctable error.

Example 21 includes any example, wherein the first core is to access interrupts of the first type and perform one or more of: provide an acknowledgement of receipt of the interrupts or perform a corrective action for the interrupts.

Example 22 includes any example, and including instructions stored thereon, that if executed cause at least one processor to: gather zero or more interrupts of the first type and provide the gathered zero or more interrupts of the first type to the first core after a threshold amount of time has elapsed.

What is claimed is:

1. An apparatus comprising:
at least two cores and
an interrupt manager coupled to the at least two cores, the interrupt manager to identify a type of interrupt related to errors to release to a selected strict subset of the at least two cores.

2. The apparatus of claim 1, wherein the type of interrupt comprises a hardware or software correctable error.

3. The apparatus of claim 1, wherein the type of interrupt includes a bit error corrected using error correction coding (ECC).

4. The apparatus of claim 1, wherein the type of interrupt comprises one or more of: a PCIe error or a one-bit read error.

5. The apparatus of claim 1, wherein the interrupt manager is to gather the type of interrupt during a time span release and release the gathered zero or more interrupts to the selected strict subset of the at least two cores based on completion of the time span.

6. The apparatus of claim 5, wherein the selected strict subset of the at least two cores is to access interrupts of the type of interrupt and cause performance of a corrective action for the gathered zero or more interrupts.

7. The apparatus of claim 5, wherein the selected strict subset of the at least two cores is to access interrupts of the type of interrupt and provide an acknowledgement of receipt of the interrupts but not perform a corrective action for the gathered zero or more interrupts.

8. The apparatus of claim 1, comprising a memory controller to issue an interrupt to the interrupt manager.

9. The apparatus of claim 1, comprising one or more of: a base station, macro base station, pico station, or nano station.

10. The apparatus of claim 1, wherein the interrupt manager is to transfer to one or more cores interrupts that are associated with faults that are not correctable by an interrupt issuer or its delegate.

11. The apparatus of claim 1, wherein the interrupt manager is to provide an interrupt without coalescing to a second core, the second core to perform a network protocol processing task related to one or more of: Data Plane Development Kit (DPDK) applications, 3GPP 5G protocol processing, Network Function Virtualization (NFV) operation, software-defined networking (SDN), virtualized network function (VNF), cloud radio access network (CRAN or C-RAN), virtualized radio access network (VRAN), Evolved Packet Core (EPC), broadband remote access server (BRAS), or Broadband Network Gateway (BNG) workloads.

12. A method comprising:
receiving an interrupt and
determining whether to transfer the interrupt to a processor or to steer the interrupt to a second processor, wherein the processor is to perform network protocol processing, real-time scheduling, or service chaining operations.

13. The method of claim 12, comprising:
determining to transfer the interrupt to the processor based on the interrupt referring to an error that is not correctable by an issuer of the interrupt or its delegate.

14. The method of claim 12, comprising:
gathering a type of interrupt during a time span and
providing zero or more interrupts of the type of interrupt to a third processor based on a timer expiring.

15. The method of claim 14, wherein the type of interrupt comprises a type of interrupt related to an error that is correctable by an issuer of the interrupt or its delegate.

16. The method of claim 14, wherein the type of interrupt comprises a single or multiple bit error that is correctable by an issuer of the interrupt or its delegate.

17. The method of claim 14, comprising:
the third processor performing one or more of: a corrective action related to the interrupt or providing an acknowledgement of receipt of the interrupt.

18. The method of claim 12, wherein the network protocol processing comprise operations related to one or more of: Data Plane Development Kit (DPDK) applications, 3GPP 5G protocol processing, Network Function Virtualization (NFV) operation, software-defined networking (SDN), virtualized network function (VNF), cloud radio access network (CRAN or C-RAN), virtualized radio access network (VRAN), Evolved Packet Core (EPC), broadband remote access server (BRAS), or Broadband Network Gateway (BNG) workloads.

19. A computer-readable medium, comprising instructions stored thereon, that if executed cause at least one processor to:
configure interrupt management features to transfer interrupts of a first type to a first core and
configure interrupt management features to transfer interrupts of a second type to a second core, wherein the second core is to execute any packet processing-related task.

20. The computer-readable medium of claim 19, wherein the first type comprises a hardware or software correctable error.

21. The computer-readable medium of claim 19, wherein the first core is to access interrupts of the first type and perform one or more of: provide an acknowledgement of receipt of the interrupts or perform a corrective action for the interrupts.

22. The computer-readable medium of claim 19, comprising instructions stored thereon, that if executed cause at least one processor to:
gather zero or more interrupts of the first type and provide the gathered zero or more interrupts of the first type to the first core after a threshold amount of time has elapsed.
